(19) United States
(12) Patent Application Publication
(10) Pub. No.: US 2022/0084043 A1
(43) Pub. Date: Mar. 17, 2022

(54) BEVERAGE PRODUCER AUTHENTICITY VERIFICATION METHOD AND SYSTEM

(71) Applicant: Cellr Pty Ltd, Bibra Lake (AU)

(72) Inventors: Michael David Mickel, Bibra Lake, Western Australia (AU); Christopher Michael Braine, Bibra Lake, Western Australia (AU)

(73) Assignee: Cellr Pty Ltd, Bibra Lake (AU)

(21) Appl. No.: 17/425,185

(22) PCT Filed: Jan. 21, 2020
(86) PCT No.: PCT/AU2020/050030

§ 371 Date: Jul. 22, 2021

(30) Foreign Application Priority Data
Jan. 23, 2019 (AU) 2019900213

(51) Int. Cl. G06Q 30/00

(52) U.S. Cl. CPC G06Q 30/018

(57) ABSTRACT

Provided is an oenological producer authenticity verification system (400) which comprises an interface (402) which is configured to record, via a communications network including a blockchain (200), oenological characteristics of a wine for bottling in the blockchain as part of a bottling process (412). The system (400) further includes a processing system (100) configured to, as said wine is bottled (404) into a plurality of bottles (indicated by reference numeral 414) each having an irreversible binary-state automatic identification and data capture (AIDC) sealing arrangement (600), associate the recorded oenological characteristics with each unique bottle identifier in the blockchain.

### TECHNICAL FIELD

This invention relates to the field of beverage production, such as distillation, oenology, viniculture or winemaking, in general, and more particularly to a method and associated system for oenological producer authenticity verification, an irreversible binary-state automatic identification and data capture (AIDC) sealing arrangement for a beverage container, as well as a computer programme product for such a method.

### COPYRIGHT NOTICE/PERMISSION

A portion of the disclosure of this patent specification contains material that is subject to copyright protection. The copyright owner has no objection to the facsimile reproduction by anyone of the patent specification or parts thereof as it appears in the file or records of a Patent Office, but otherwise reserves all copyrights whatsoever.

### BACKGROUND ART

The following discussion of the background art is intended to facilitate an understanding of the present invention only. The discussion is not an acknowledgement or admission that any of the material referred to is or was part of the common general knowledge as at the priority date of the application.

Wine fraud, and especially wine counterfeiting and the relabeling of inferior and cheaper wines to more expensive brands, is a common type of fraud worldwide. It is estimated that anywhere between approximately 5% to 20% of the wine sold in auctions and other secondary markets is counterfeit, particularly in the high-end wine industry. Similarly, other beverage fraud is also a problem, which can be relevant to beverages like whiskey, sake, or the like.

Accordingly, there exists a need in the art for means whereby a person is able to easily and securely verify the veracity of a bottle of produced beverage, such as wine or whiskey. The present invention was conceived with this need in mind.

### SUMMARY OF THE INVENTION

As will be understood by the skilled addressee, a blockchain is a distributed electronic ledger which is a publicly or privately accessible database that maintains a continuously-growing list of electronic data records hardened against tampering and revision. A blockchain typically consists of data structure blocks with each block holding batches of individual transactions. Each block contains a timestamp and information linking it to a previous block, typically via a hash of the prior block. The linked blocks form a chain, with each additional block reinforcing those before it. A blockchain is generally peer-to-peer over an open or private communications network, such as the Internet or private network, where every authorised user on the network is allowed to connect to the blockchain ledger, send new transactions to it, verify transactions, and create new blocks or immutable records.

It is further to be understood that reference herein to a ‘GUI’ refers to a Graphical User Interface, being a user interface that allows a user to interact with an electronic device, such as a terminal, processing or computing system through manipulation of graphical icons, visual indicators, text-based typed command labels and/or text navigation, including primary and/or secondary notations, as is known in the art of computer science.

The skilled addressee will also appreciate that reference herein to the phrase ‘automatic identification and data capture’ (AIDC) generally refers to any suitable technique of methodology for automatically and without user data entry, identifying an object and entering relevant data directly into a computer system (i.e. without human involvement). Examples of AIDC technologies include bar codes, Quick Response (QR) tags, Radio Frequency Identification (RFID), Near-Field Communication (NFC), data tags, magnetic stripes, smart cards, etc.

It is yet further to be appreciated that reference herein to ‘substantial real-time’ is to be understood as meaning an instance of time that may include a delay typically resulting from processing, calculation and/or transmission times inherent in computer processing systems. These transmission and calculations times, albeit of generally small duration, do introduce some measurable delay, i.e. typically less than a second or within milliseconds, but the user is provided with relevant visualisation information relatively quickly or within ‘substantial real-time’.

The skilled addressee is further to appreciate that the present invention is applicable to any type of beverage production and/or producer. As such, although reference herein is primarily made to oenological production, other forms of beverage production and associated producers are apposite, including whiskey production, sake production, etc. Accordingly, reference to ‘oenological’, ‘wine’, ‘wine bottle’, or the like, is to be taken to include any other suitable beverage producer, production or suitable beverage container. In addition, as referenced herein, a ‘producer’ and associated beverage ‘production’ may be used interchangeably as relevant without unnecessarily altering the overall scope of the invention.

In accordance with a first aspect of the invention, there is provided a method for oenological producer authenticity verification, said method comprising the steps of:

as part of a bottling process, recording, via a communications network including a blockchain, oenological characteristics of a wine for bottling in the blockchain;

bottling said wine into a plurality of bottles each having an irreversible binary-state automatic identification and data capture (AIDC) sealing arrangement capable of uniquely identifying each bottle via a unique bottle identifier, each binary-state AIDC arrangement once variable from an ‘unopened’ to an ‘open’ state;

associating the recorded oenological characteristics with each unique bottle identifier in the blockchain; and

operatively providing an on-demand GUI via the network, said GUI configured to enable a user to scan an AIDC sealing arrangement and to verify that an associated bottle identifier matches the oenological characteristics in the blockchain in substantial real-time.

Typically, the oenological characteristics are selected from a non-exhaustive group comprising grape varietal, terroir, appellation, geographical indication, viticulture indicators, oenology indicators, producer identity, winemaker details, tasting notes, date of harvest, and date of bottling. As mentioned above, it is to be appreciated that oenological characteristics may include characteristics suited to other types of beverages as well, such as whiskey, sake, or the like.

Typically, the step of recording the oenological characteristics comprises recording such characteristics via a recording GUI provided to a user at the time of bottling.

In one embodiment, the step of recording the oenological characteristics comprises providing a suitable application programming interface (API) configured to interface with existing software, such as viniculture management software, or the like.

Typically, the step of bottling comprises automatically scanning, via a suitable scanner, each AIDC sealing arrangement of a bottle before, during and/or after wine is discharged into said bottle.

Typically, the irreversible binary-state AIDC sealing arrangement comprises a frangible AIDC indicator configured for operative fitment to and/or about a stopper of a wine bottle, said indicator configured to self-destruct upon removal of said stopper, said sealing arrangement capable of uniquely identifying the bottle via a unique bottle identifier, each binary-state AIDC arrangement once variable from an ‘unopened’ to an ‘open’ state as said stopper is removed.

Typically, the frangible AIDC indicator comprises a frangible waveguide for an electromagnetically-readable AIDC tag, e.g. an RFID tag, an NFC tag, or the like.

Typically, the stopper is selected from a non-exhaustive group consisting of a screw-cap, a cap seal, a metal cap, a wax seal and a cork.

Typically, the bottle identifier includes a unique serial number uniquely associable with said bottle in the blockchain.

Typically, the GUI is configured to enable a user to scan an AIDC sealing arrangement by interfacing with a smartphone handset or the like of said user having some manner of AIDC scanner, i.e. a camera, NFC scanner, RFID scanner, etc.

In one embodiment, the method includes the step of capturing and recording an AIDC identifier of a shipping container wherein at least one bottle is shipped, said shipping container associated with at least one bottle therein in the blockchain.

In one embodiment, the method includes the step of updating the blockchain with logistical occurrences indicative of a history of bottle movement, so that a user is able to trace and monitor movement of said bottle after bottling.

According to a second aspect of the invention there is provided an oenological producer authenticity verification system comprising:

an interface configured to record, via a communications network including a blockchain, oenological characteristics of a wine for bottling in the blockchain as part of a bottling process; and

a processing system configured to, as said wine is bottled into a plurality of bottles each having an irreversible binary-state automatic identification and data capture (AIDC) sealing arrangement capable of uniquely identifying each bottle via a unique bottle identifier, each binary-state AIDC arrangement once variable from an ‘unopened’ to an ‘open’ state, associate the recorded oenological characteristics with each unique bottle identifier in the blockchain, said processing system further configured to provide an on-demand GUI via the network, said GUI configured to enable a user to scan an AIDC sealing arrangement and to verify that an associated bottle identifier matches the oenological characteristics in the blockchain in substantial real-time.

Typically, the oenological characteristics are selected from a non-exhaustive group comprising grape varietal, terroir, appellation, geographical indication, viticulture indicators, oenology indicators, tasting notes, date of harvest, and date of bottling.

Typically, the interface comprises a GUI provided via a processing system of a wine producer and/or wine bottler to record the oenological characteristics at the time of bottling.

In one embodiment, the interface records the oenological characteristics via a suitable application programming interface (API) configured to interface with existing software, such as viniculture management software, or the like.

Typically, the processing system is configured to automatically scan, via a suitable scanner, each AIDC sealing arrangement of a bottle before, during and/or after wine is discharged into said bottle during bottling.

Typically, the irreversible binary-state AIDC sealing arrangement comprises a frangible AIDC indicator configured for operative fitment to and/or about a stopper of a wine bottle, said indicator configured to self-destruct upon removal of said stopper, said sealing arrangement capable of uniquely identifying the bottle via a unique bottle identifier, each binary-state AIDC arrangement once variable from an ‘unopened’ to an ‘open’ state as said stopper is removed.

Typically, the frangible AIDC indicator comprises a frangible waveguide for an electromagnetically-readable AIDC tag, e.g. an RFID tag, an NFC tag, or the like.

Typically, the stopper is selected from a non-exhaustive group consisting of a screw-cap, a cap seal, a metal cap, a wax seal and a cork.

Typically, the bottle identifier includes a unique serial number uniquely associable with said bottle in the blockchain.

Typically, the GUI is configured to enable a user to scan an AIDC sealing arrangement by interfacing with a smartphone handset or similar device of said user having some manner of AIDC scanner, i.e. a camera, NFC scanner, RFID scanner, etc.

In one embodiment, the processing system is configured to capture and record an AIDC identifier of a shipping container wherein at least one bottle is shipped, said shipping container associated with at least one bottle therein in the blockchain.

In one embodiment, the processing system is configured to update the blockchain with logistical occurrences indicative of a history of bottle movement, so that a user is able to trace and monitor movement of said bottle after bottling via the GUI.

According to a third aspect of the invention there is provided an irreversible binary-state automatic identification and data capture (AIDC) sealing arrangement for a beverage container, said sealing arrangement comprising:

a frangible AIDC indicator configured for operative fitment to and/or about a stopper of a beverage container, such as a wine bottle, said indicator configured to self-destruct upon removal of said stopper, said sealing arrangement capable of uniquely identifying a beverage container via a unique bottle identifier, each binary-state AIDC arrangement once variable from an ‘unopened’ to an ‘open’ state as said stopper is removed.

Typically, the frangible AIDC indicator comprises a frangible waveguide for an electromagnetically-readable AIDC tag, e.g. an RFID tag, an NFC tag, or the like.

Typically, the stopper is selected from a non-exhaustive group consisting of a screw-cap, a cap seal, a metal cap, a wax seal and a cork.

According to a further aspect of the invention there is provided a computer programme product which, when executed by a suitable processing system, facilitates the performance of the method according to the first aspect of the present invention.

### BRIEF DESCRIPTION OF THE DRAWINGS

The description will be made with reference to the accompanying drawings in which:

FIG. 1 illustrates a functional block diagram of an example processing system that can be utilised to embody or give effect to a particular embodiment of the oenological producer authenticity verification system, in accordance with an aspect of the present invention;

FIG. 2 illustrates an example network infrastructure that can be utilised to embody or give effect to a particular embodiment of a communications network whereby the processing system of FIG. 1 can communicate with users of said system;

FIG. 3 is a diagrammatic representation of method steps for an oenological producer authenticity verification method, in accordance with an aspect of the present invention;

FIG. 4 is a diagrammatic overview representation of an embodiment of an oenological producer authenticity verification system, in accordance with an aspect of the present invention;

FIG. 5 is a diagrammatic overview representation of possible users of the oenological producer authenticity verification system of FIG. 4 during a typical wine logistical process; and

FIGS. 6A to 6C are diagrammatic perspective-view representations of embodiments of an irreversible binary-state automatic identification and data capture (AIDC) sealing arrangement for a beverage container, such as a bottle of wine, in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

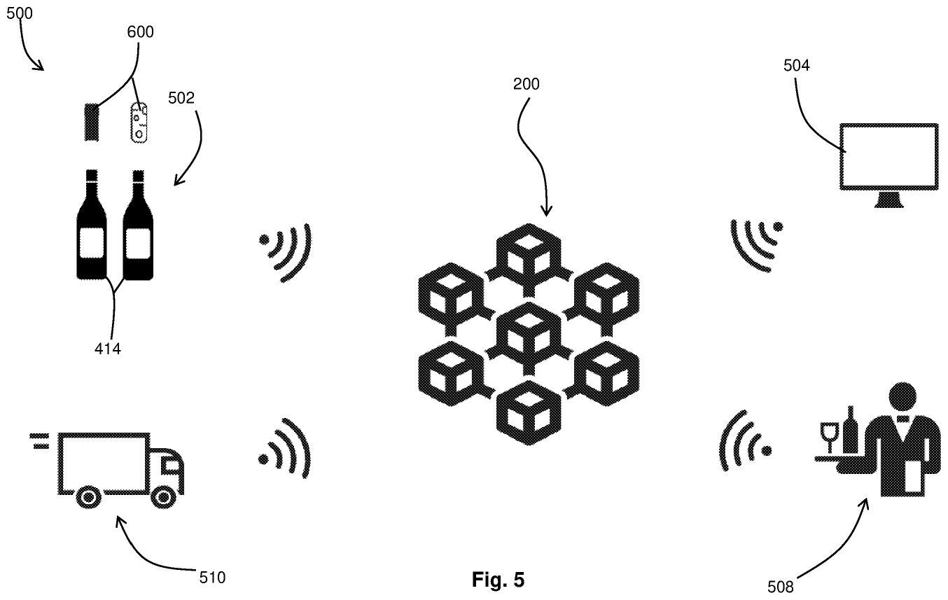

Broadly, the present invention provides for a method 300 and associated system 400 for oenological producer authenticity verification. Such a method is generally at least partly computer-implemented, typically requiring a number of processing systems 100 communicating via a suitable communications network 200, as described below. Similarly, the system 400 typically comprises a number of processing systems 100 and their interactions to function, as indicated generally by reference numeral 500 in FIG. 5.

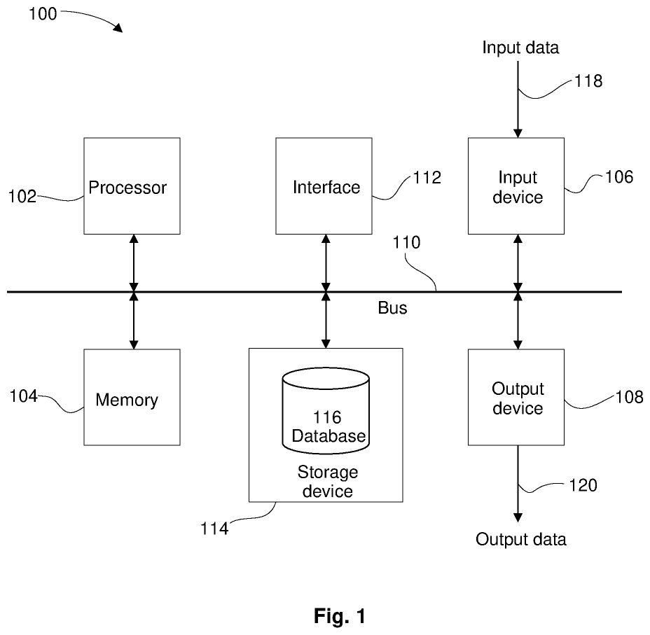

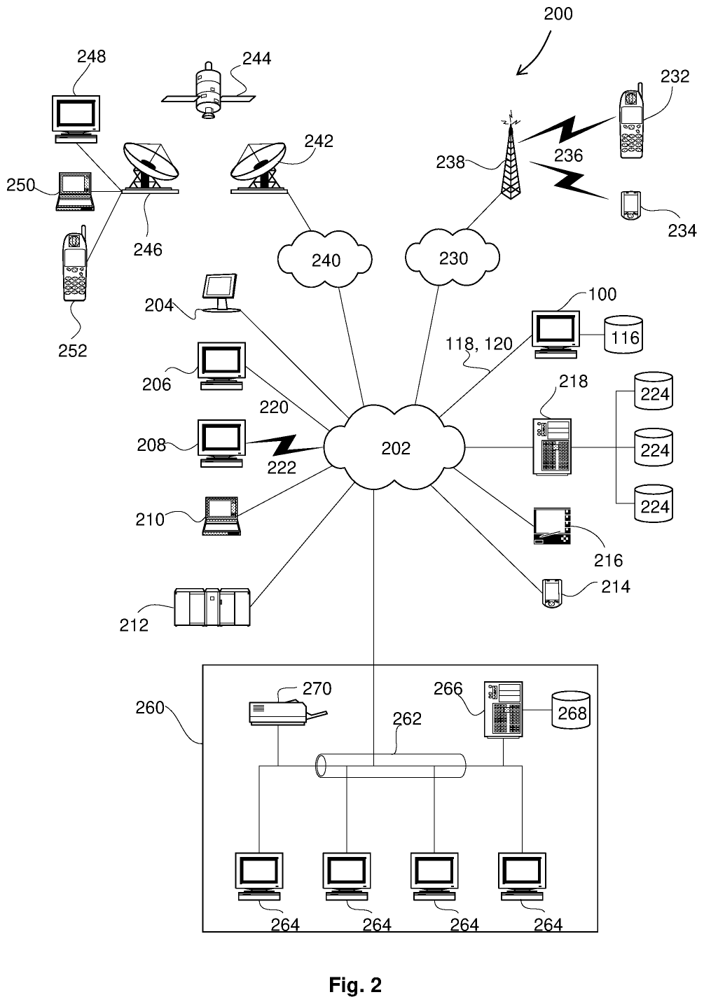

Accordingly, referring firstly to FIGS. 1 and 2 of the accompanying drawings, there is shown a broad example of a processing system 100 that can be used, in different configurations as will be readily apparent to the skilled addressee, to implement the broad oenological producer authenticity verification system 400, as well as end-user devices, again diagrammatically indicated by end-users 504, 508, 510 in FIG. 5. Similarly, FIG. 2 shows a broad example of a networked communications system 200 whereby the respective processing systems can be arranged in signal communication.

It is to be appreciated that any reference herein to “means” specifically includes any one or more of a computer programme product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

As is known in the art of computer programming, an application programming interface (API) is a set of subroutine definitions, communication protocols, and tools for building software. In general terms, it is a set of clearly defined methods of communication among various components. Means for facilitating any of the communications or interactions between processing system 100 and end-user devices 504, 508, 510 via network 200 (which includes a blockchain) may be facilitated via suitable APIs within processing system 100 or network 200, as will be readily apparent to the skilled addressee.

Referring now to FIGS. 1 and 2, by way of background, in a general networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid-state drive.

An information source can include a server, or any type of terminal, that may be associated with one or more storage devices that are able to store information or data, for example in one or more databases residing on a storage device. The exchange of information (i.e. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The Internet, which often serves as an enabling part of communications network 200, is the large-scale interconnection of public and private networks. The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices. More than one distinct network can be provided, for example a private and a public network. A network as referenced in this specification should be taken to include any type of processing system 100, terminal or other similar type of electronic device, or part thereof, which is rendered such that it is capable of communicating with at least one other processing system 100 or terminal.

One example of facilitating communication across such networks, is the Hyper-Text Mark-Up Language (HTML) and Hyper-Text Transfer Protocol (HTTP), and developments thereof, which have made the Internet or World Wide Web (WWW) very accessible. The exchange of information on the Internet is further facilitated through hyper-text documents. Hyper-Text documents are unique in that they use tags to define links which, when selected, retrieve the related information from within the same document or from a new document altogether.

The links are defined using HTML which provides a document formatting method which adapts in a consistent manner to any computer on which it is displayed. HTML tags are used to define various components of text, visual or audio which make up a hyper-text document, including such things as formatting and linking to other documents. HTML tags which link documents on one Internet information source to those on another do so by associating a Uniform Resource Locator (URL) with the referenced information. The skilled addressee will appreciate that other communication protocols may be used and are within the scope of the present invention.

In light of this background, the processing system 100 of FIG. 1 generally includes at least one processor 102, or processing unit or plurality of processors, memory 104, at least one input device 106 and at least one output device 108, coupled together via a bus or group of buses 110. Typically, the processor 102 comprises any suitable processor or microcontroller configured to receive input, perform logical and arithmetical operations on a suitable instruction set, and provide output, as well as transitory and/or non-transitory electronic storage, such as memory 104 and storage device 114, or the like.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice-controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network, or a dedicated global navigation satellite system (GNNS) sensor, as is known in the art, or the like. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a touchscreen, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, smartphone, or the like.

As described, the processing system 100 is generally part of a networked communications system 200, as shown in FIG. 2. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200. Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

Accordingly, in the manner described above, the oenological producer authenticity verification system 400 is generally realised by suitable versions of the processing system 100, as described above, and networked together to perform the functions and provide the features broadly described herein.

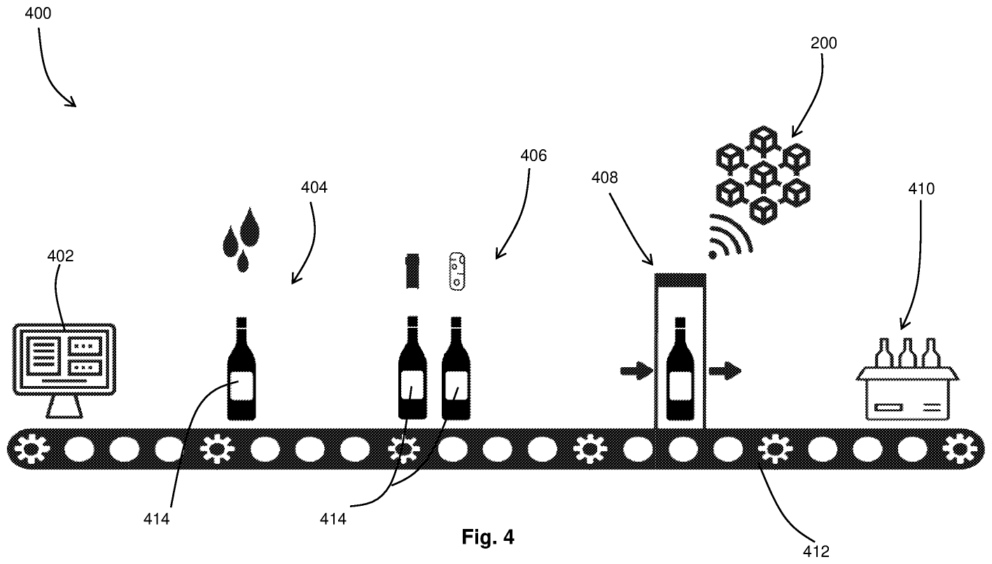

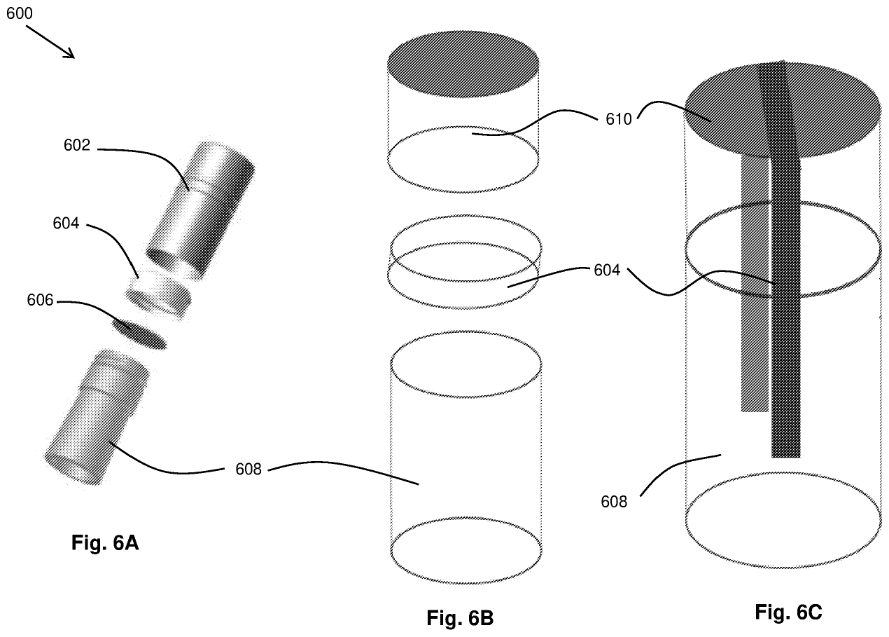

With reference now to FIG. 4, there is shown one broad example of such an oenological producer authenticity verification system 400. In the exemplified embodiment, the system 400 comprises an interface 402 which is configured to record, via a communications network including a blockchain 200 (as described above), oenological characteristics of a wine for bottling in the blockchain as part of a bottling process 412. The system 400 further includes a processing system 100 configured to, as said wine is bottled 404 into a plurality of bottles (indicated by reference numeral 414) each having an irreversible binary-state automatic identification and data capture (AIDC) sealing arrangement 600 (described below with reference to FIG. 6), associate the recorded oenological characteristics with each unique bottle identifier in the blockchain. Such a sealing arrangement 600 is generally used to seal each bottle 414 immediately after bottling 404 as part of the bottling process 412, as is known in the conventional art of wine bottling.

As described above, the skilled addressee is to appreciate that reference herein to a wine bottle includes reference to any suitable container for a beverage and that the present invention is not limited to a wine bottle alone. Other containers and beverages may be substituted without altering the scope of the present invention.

Typically, the interface 402 comprises a GUI provided via a processing system 100 of a wine producer to record the oenological characteristics at the time of bottling. The interface 402 may record the oenological characteristics via a suitable application programming interface (API) configured to interface with existing software, such as viniculture management software, bottling software, or the like, as is well-known in the art. Such API interface also improves uptake of the system 400, as no substantial changes to an existing bottling and/or wine management software are necessary.

The processing system of system 400 is further configured to provide an on-demand GUI via the network 200, as diagrammatically represented in FIG. 5. Said GUI is configured to enable an end-user to scan an AIDC sealing arrangement 600 and to verify that an associated bottle identifier matches the oenological characteristics in the blockchain in substantial real-time.

As each AIDC sealing arrangement 600 is capable of uniquely identifying each bottle via a unique bottle identifier, and each binary-state AIDC arrangement 600 is once variable from an ‘unopened’ to an ‘open’ state, the system allows an end-user to confirm the veracity of said wine within a bottle via the blockchain network 200, typically the Internet.

For example, with reference to FIG. 5 showing some end-user examples, an end-user is able to access network 200 including the blockchain, to check that a wine is what it is supposed to be. As long as a bottle 414, fitted with sealing arrangement 600, remains unopened, i.e. the binary-state AIDC arrangement reports an ‘unopened’ state, said AIDC sealing arrangement 600 can be scanned and compared with a value stored securely in the blockchain. In this manner, should a bottle 414 be refilled with a fraudulent representation of a wine, and such a bottle not have a valid sealing arrangement 600, and end-user will know there is something amiss with the bottle. As many people across the world use smartphones on a daily basis, a preferred embodiment envisages the GUI as part of a smartphone application or app, combined with a suitable reader or scanner, whereby a wine bottle can be scanned and the blockchain checked for comparison.

As a result, a potential buyer of a wine can verify an authenticity of a bottle at a point-of-sale 504, or a restaurant (or even patron) can check a bottle when ordered 508, or a wholesale purchaser 510 can check an entire consignment, as any verified and unopened wine 502 will appear as part of the blockchain record.

The oenological characteristics of a wine recorded in the blockchain are essentially limited only by requirement, and any details concerning grape varietal, terroir, appellation, geographical indication, viticulture indicators, oenology indicators, tasting notes, date of harvest, date of bottling, producer identity, winemaker details, etc. can be captured at the time of bottling and sealing. Other aspects are, of course, possible and within the scope of the present invention, such as characteristics relevant to, for example, whiskey production, or the like.

The processing system 400 is generally configured to automatically scan, via a suitable scanner 408, each AIDC sealing arrangement of a bottle 414 before, during and/or after wine is discharged into said bottle during the bottling process 412. Adding such a scanner 408 to an existing bottling process presents a minor engineering challenge without requiring an extensive reconfiguration of such an existing operation. Once scanned, a bottle identifier can include a unique serial number which is uniquely associable with said bottle in the blockchain, or the like.

The GUI provided to the end-user is also typically configured to enable such a user to scan an AIDC sealing arrangement 600 by interfacing with a smartphone handset or similar device of the user having some manner of AIDC scanner, i.e. a camera, NFC scanner, RFID scanner, etc. Such AIDC scanning techniques are well-known in the art and will not be described in any detail.

In one embodiment, the processing system 400 is also typically configured to capture and record an AIDC identifier of a shipping container 410 wherein at least one bottle is shipped, said shipping container associated with at least one bottle therein in the blockchain. Such shipping container scanning can provide an additional level of authentication and associated veracity monitoring, as a bottle can be linked to a container with both traceable at a final destination.

Accordingly, in one embodiment, the processing system 400 may be configured to update the blockchain with logistical occurrences indicative of a history of bottle movement, so that a user is able to trace and monitor movement of said bottle and/or shipping container after bottling via the GUI.

With reference now to FIG. 6 of the accompanying drawings, there is shown examples of irreversible binary-state automatic identification and data capture (AIDC) sealing arrangements 600 for a beverage container, such as a wine bottle. The sealing arrangement 600 generally comprises a frangible AIDC indicator 604 which is configured for operative fitment to and/or about a stopper 610 of the beverage container, represented by wine bottle 608. Such a stopper 610 can include a screw-cap, a cap seal, a metal cap, a wax seal or a cork, as in known in the art. The AIDC indicator 604 may also form part of or be incorporated in a conventional seal 606, or the like.

The indicator 604 is generally configured to self-destruct upon removal of the stopper, so that each binary-state AIDC arrangement 600 is once variable from an ‘unopened’ to an ‘open’ state as the stopper 610 is removed. Typically, the frangible AIDC indicator 604 comprises a frangible waveguide for an electromagnetically-readable AIDC tag, e.g. an RFID tag, an NFC tag, or the like. When the stopper 610 is removed or a seal is broken, the waveguide is irreparably destroyed such that either no signal or a different signal is produced when scanned, i.e. the AIDC arrangement 600 changes irreversibly from the ‘unopened’ to the ‘open’ state. In this manner, opening a wine bottle having the AIDC sealing arrangement 600 makes it differ from the bottle identifier recorded in the blockchain, which can be tracked and verified.

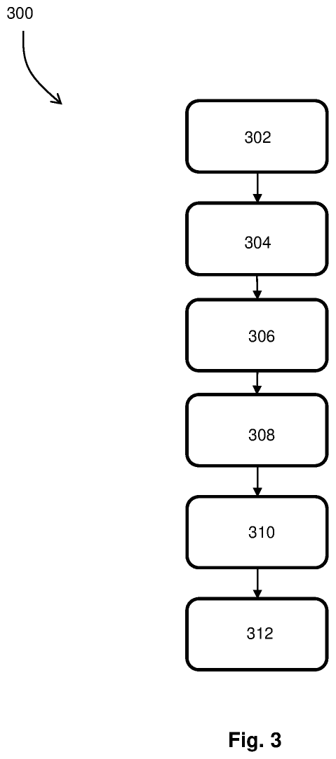

Referring now to FIG. 3 of the accompanying drawings, there is shown an associated method 300 for oenological producer authenticity verification. Such a method 300 generally comprises the steps of, as part of a bottling process, recording 302, via a communications network including a blockchain, the oenological characteristics of a wine for bottling in the blockchain; bottling 304 said wine into a plurality of bottles each having an AIDC sealing arrangement 600 capable of uniquely identifying each bottle; associating 306 the recorded oenological characteristics with each unique bottle identifier in the blockchain; and operatively providing 308 an on-demand GUI via the network, said GUI configured to enable a user to scan an AIDC sealing arrangement and to verify that an associated bottle identifier matches the oenological characteristics in the blockchain in substantial real-time.

In one embodiment, the method 300 includes the step of capturing and recording 310 an AIDC identifier of a shipping container wherein at least one bottle is shipped, said shipping container associated with at least one bottle therein in the blockchain.

In a further embodiment, the method 300 includes the step of updating 312 the blockchain with logistical occurrences indicative of a history of bottle movement, so that a user is able to trace and monitor movement of said bottle after bottling.

In use, as described above, the system 400 and method 300 enables a wine producer to produce a wine and to record the specific details of the wine, including its origin, in the blockchain at the time of bottling. The wine can then undergo a conventional logistical process of wine sale and distribution and each unique AIDC sealing arrangement can be scanned on-demand at each stage of the process to check that the wine is what it purports to be, as recorded in the blockchain.

The Applicant believes it advantageous that the invention described herein allows for an elegant and efficient way to update existing wine bottling practices and provide an irrefutable means for an end-user to verify the authenticity of a wine at any stage of a wine sale and distribution process. Even should sealing arrangement 600 be counterfeited to produce a unique bottle identifier, the recordation of such bottle identifier against specific oenology characteristics at the time of bottling cannot be counterfeited, as the blockchain can be checked to ensure that the recorded bottle identifier matches the recorded oenology characteristics at the time of bottling, which cannot be falsified in the blockchain.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1-29. (canceled)

30. An oenological producer authenticity verification system comprising:
an interface configured to record, via a communications network including a blockchain, oenological characteristics of a wine for bottling in the blockchain as part of a bottling process; and
a processing system configured to, as said wine is bottled into a plurality of bottles each having an irreversible binary-state automatic identification and data capture (AIDC) sealing arrangement capable of uniquely identifying each bottle via a unique bottle identifier, each binary-state AIDC arrangement once variable from an ‘unopened’ to an ‘open’ state, associate the recorded oenological characteristics with each unique bottle identifier in the blockchain, said processing system further configured to provide an on-demand GUI via the network, said GUI configured to enable a user to scan an AIDC sealing arrangement and to verify that an associated bottle identifier matches the oenological characteristics in the blockchain in substantial real-time.

31. The system of claim 30, wherein the oenological characteristics are selected from a non-exhaustive group comprising grape varietal, terroir, appellation, geographical indication, viticulture indicators, oenology indicators, tasting notes, date of harvest, and date of bottling.

32. The system of claim 30, wherein the interface comprises a GUI provided via a processing system of a wine producer and/or wine bottler to record the oenological characteristics at the time of bottling.

33. The system of claim 30, wherein the interface records the oenological characteristics via a suitable application programming interface (API) configured to interface with existing software.

34. The system of claim 30, wherein the processing system is configured to automatically scan, via a suitable scanner, each AIDC sealing arrangement of a bottle before, during and/or after wine is discharged into said bottle during bottling.

35. The system of claim 30, wherein the irreversible binary-state AIDC sealing arrangement comprises a frangible AIDC indicator configured for operative fitment to and/or about a stopper of a wine bottle, said indicator configured to self-destruct upon removal of said stopper, said sealing arrangement capable of uniquely identifying the bottle via a unique bottle identifier, each binary-state AIDC arrangement once variable from an ‘unopened’ to an ‘open’ state as said stopper is removed.

36. The system of claim 35, wherein the frangible AIDC indicator comprises a frangible waveguide for an electromagnetically-readable AIDC tag, an RFID tag, or an NFC tag.

37. The system of claim 35, wherein the stopper is selected from a non-exhaustive group consisting of a screw-cap, a cap seal, a metal cap, a wax seal and a cork.

38. The system of claim 30, wherein the bottle identifier includes a unique serial number uniquely associable with said bottle in the blockchain.

39. The system of claim 30, wherein the GUI is configured to enable a user to scan an AIDC sealing arrangement by interfacing with a smartphone handset or similar device of said user having one or more of a AIDC scanner, a camera, NFC scanner, and RFID scanner.

40. The system of claim 30, wherein the processing system is configured to capture and record an AIDC identifier of a shipping container wherein at least one bottle is shipped, said shipping container associated with at least one bottle therein in the blockchain.

41. The system of claim 30, wherein the processing system is configured to update the blockchain with logistical occurrences indicative of a history of bottle movement, so that a user is able to trace and monitor movement of said bottle after bottling via the GUI.

42. An irreversible binary-state automatic identification and data capture (AIDC) sealing arrangement for a beverage container, said sealing arrangement comprising:
a frangible AIDC indicator configured for operative fitment to and/or about a stopper of a beverage container, said indicator configured to self-destruct upon removal of said stopper, said sealing arrangement capable of uniquely identifying a beverage container via a unique bottle identifier, each binary-state AIDC arrangement once variable from an ‘unopened’ to an ‘open’ state as said stopper is removed.

43. The sealing arrangement of claim 42, wherein the frangible AIDC indicator comprises a frangible waveguide for an electromagnetically-readable AIDC tag, a RFID tag, or a NFC tag.

44. The sealing arrangement of claim 42, wherein the stopper is selected from a non-exhaustive group consisting of a screw-cap, a cap seal, a metal cap, a wax seal and a cork.

45. A method for oenological producer authenticity verification, said method comprising the steps of:
as part of a bottling process, recording, via a communications network including a blockchain, oenological characteristics of a wine for bottling in the blockchain;
bottling said wine into a plurality of bottles each having an irreversible binary-state automatic identification and data capture (AIDC) sealing arrangement capable of uniquely identifying each bottle via a unique bottle identifier, each binary-state AIDC arrangement once variable from an ‘unopened’ to an ‘open’ state;
associating the recorded oenological characteristics with each unique bottle identifier in the blockchain; and
operatively providing an on-demand GUI via the network, said GUI configured to enable a user to scan an AIDC sealing arrangement and to verify that an associated bottle identifier matches the oenological characteristics in the blockchain in substantial real-time.

46. The method of claim 45, wherein the oenological characteristics are selected from a non-exhaustive group comprising grape varietal, terroir, appellation, geographical indication, viticulture indicators, oenology indicators, producer identity, winemaker details, tasting notes, date of harvest, and date of bottling.

47. The method of claim 45, wherein the step of recording the oenological characteristics comprises recording such characteristics via a recording GUI provided to a user at the time of bottling.

48. The method of claim 45, wherein the step of recording the oenological characteristics comprises providing a suitable application programming interface (API) configured to interface with existing software.

49. The method of claim 45, wherein the step of bottling comprises automatically scanning, via a suitable scanner, each AIDC sealing arrangement of a bottle before, during and/or after wine is discharged into said bottle.

50. The method of claim 45, wherein the irreversible binary-state AIDC sealing arrangement comprises a frangible AIDC indicator configured for operative fitment to and/or about a stopper of a wine bottle, said indicator configured to self-destruct upon removal of said stopper, said sealing arrangement capable of uniquely identifying the bottle via a unique bottle identifier, each binary-state AIDC arrangement once variable from an ‘unopened’ to an ‘open’ state as said stopper is removed.

51. The method of claim 45, wherein the frangible AIDC indicator comprises a frangible waveguide for an electromagnetically-readable AIDC tag, e.g. an RFID tag, an NFC tag, or the like.

52. The method of claim 50, wherein the stopper is selected from a non-exhaustive group consisting of a screw-cap, a cap seal, a metal cap, a wax seal and a cork.

53. The method of claim 45, wherein the bottle identifier includes a unique serial number uniquely associable with said bottle in the blockchain.

54. The method of claim 45, wherein the GUI is configured to enable a user to scan an AIDC sealing arrangement by interfacing with a smartphone handset of said user having one or more of an AIDC scanner, a camera, NFC scanner, and RFID scanner.

55. The method of claim 45, wherein the method includes the step of capturing and recording an AIDC identifier of a shipping container wherein at least one bottle is shipped, said shipping container associated with at least one bottle therein in the blockchain.

56. The method of claim 45, wherein the method includes the step of updating the blockchain with logistical occurrences indicative of a history of bottle movement, so that a user is able to trace and monitor movement of said bottle after bottling.

57. A computer programme product which, when executed by a suitable processing system, facilitates the performance of the method in accordance with claim 45.
